(19) United States
(12) Patent Application Publication
(10) Pub. No.: US 2007/0148045 A1
(43) Pub. Date: Jun. 28, 2007

(54) Optoelectronic system for particle detection

(75) Inventors: Allen Pu, San Gabriel, CA (US); Demetri Psaltis, St-Sulpice (CH)

Correspondence Address: HISCOCK & BARCLAY, LLP, 2000 HSBC PLAZA, 100 Chestnut Street, ROCHESTER, NY, 14604-2404, US

(73) Assignee: California Institute of Technology, Pasadena, CA (US)

(21) Appl. No.: 11/546,701

(22) Filed: Oct. 12, 2006

Related U.S. Application Data
(60) Provisional application No. 60/726,059, filed on Oct. 12, 2005.

(51) Int. Cl. G01N 21/00

(52) U.S. Cl. 422/82.05

(57) ABSTRACT

The invention provides a particle detection system. In one embodiment, the system detects live bacteria by aligning the bacteria in a test specimen with an electric field, illuminating the test specimen, and detecting the optical scattering. This invention uses no biochemical markers and can be applied in a Point-of-Care setting.

### CROSS-REFERENCE TO RELATED APPLICATIONS

This application claims priority to and the benefit of U.S. provisional patent application Ser. No. 60/726,059, filed Oct. 12, 2005, which application is incorporated herein by reference in its entirety.

### FIELD OF THE INVENTION

The invention relates to detection and analysis systems in general and particularly to a system that employs optical and electrical interactions in a preferred embodiment in order to detect and analyze dielectric and non-isometric analytes, for example, pathogenic microorganisms.

### BACKGROUND OF THE INVENTION

Current microorganism detection methods include conventional culture, antibody detection, and the use of biosensors. While conventional culture methods remain the most reliable techniques for bacterial detection, they are also the most labor and time intensive, generally taking 12 to 24 hours to obtain initial results. The most common procedure is to culture the suspected sample using the following procedure: implant sample in Agar plate, incubate for 24-48 hours at 37° C., stain suspected growth using various chemicals, and observe under a microscope. In healthcare, samples are typically taken from patients in-office or at test clinics and are sent to centralized laboratories. It typically takes several days to receive the test result. Due to the long delay, doctors often prescribe antibiotics at the initial visit without knowing the exact bacteria to treat or if there is an infection at all. This has led to unnecessary costs and the over prescription of antibiotics.

A second approach uses antibodies to detect microorganisms. This can be completed in much less time, sometimes as little as 10 to 15 minutes with fair specificity depending on the concentration of the target antigen. However, the detection of the specific antibody-to-antigen binding requires expensive bench-top equipment unsuitable for Point-of-Care (POC) applications. Operations of such equipment also require a high level of skill and a significant amount of training. The antibody approach, therefore, has limited appeal in popular healthcare and is cost prohibitive.

More recently, researchers have developed small biosensors that detect antigen-antibody, enzyme-substrate, or receptor-ligand complexes by measuring fluorescent light, surface reflection, and electrical properties. However, these biosensors tend to be quite specific and have limited applications. If multiple organisms must be detected, multiple probes must be used, one suited to each organism, which probes can be difficult to find and/or expensive to produce. For time-sensitive applications such as urinary tract infection screening, it is highly desirable to have a rapid and broad spectrum microorganism detection device that can be used in the POC setting, and that is relatively easy to operate.

In other situations such as environmental and food monitoring, bio-warfare/bio-terrorism, and the diagnosis of rapidly advancing diseases (such as viral meningitis, antibiotic-resistant bacteria, or flesh-eating bacteria), the ability to detect and classify pathogens quickly onsite could mean the difference between life and death. Therefore, the need for a rapid, low cost and potentially portable detection system for microorganisms is widely felt across many industries.

### SUMMARY OF THE INVENTION

The microorganism or particle detection system disclosed herein are based on the following: (1) most bacteria or bacteria aggregates are irregularly shaped and their orientations are randomly distributed; (2) irregularly shaped (non-isometric), dielectric particles (e.g., individual bacteria or aggregates) immersed in a solution with a different permittivity can be polarized and aligned with an energy field, e.g., an electromagnetic field; and (3) the degree of alignment and certain biophysical characteristics of the bacteria can be measured using optical diffraction/scattering techniques. The membranes of dead cells are porous and allow ions to cross freely. Without permittivity difference between inside of the cell and the surrounding fluid, dead microorganisms (e.g., bacteria) are not dielectric and will not align under a polarizing energy field. Since alignment only occurs with live microorganisms having functional cellular membranes, the system of the present invention provides the additional benefit of distinguishing between live and dead microorganisms.

In one aspect, the invention relates to a device for detecting one or more dielectric and non-isometric analytes in a solution. The device includes:

a holder defining a loading space for loading a volume of a solution;

a source of polarizing energy in proximity to the loading space of the holder;

an optical source configured to direct a light at the loading space; and

at least one optical detector configured to detect light scattered from the loading space.

In one embodiment, the polarizing energy includes a selected one of an electromagnetic field, ultrasound, or a laser light. The source of polarizing energy and the optical detector may be located on the same or different sides of the holder. In one embodiment, at least one optical detector is located at an angle to the incoming light path from the optical source to the loading space. In one embodiment, the holder includes an electrode.

In a second aspect, the invention relates to a method for detecting one or more dielectric and non-isometric analytes in a solution. The method includes the steps of polarizing one or more dielectric and non-isometric analytes in a solution such that they are substantially aligned in the solution; and detecting the alignment of the analytes as an indication of the existence of such analytes.

In one embodiment of the method, the polarizing step includes substantially aligning the analytes along an electromagnetic field, ultrasound, or a laser light. In one embodiment, the solution includes a bodily fluid, such as urine. The analytes may include live bacteria. In one embodiment, the analytes includes an aggregate of substantially spherical particles. The analytes may also include individual particles separate from each other. The analytes can be substantially rod-shaped, or spiral-shaped. In one embodiment, the detecting step in the method uses optical means to detect the alignment of the analytes, e.g., by detecting a light scattering pattern from the solution. In one specific embodiment, the detecting step further includes detecting a change in the light scattering pattern based on whether the analytes are polarized or not.

In yet another aspect, the invention relates to a device for detecting live bacteria in a sample solution. The device includes:

a sample holder defining a channel for holding the sample;

a pair of electrodes in proximity to the sample holder and configured to apply an electric field across the channel;

an optical source configured to direct a light at the channel; and

at least one optical detector configured to detect light scattered from the channel, and capable of detecting a change in the scatter light based on whether the electrodes are connected to a source of electric potential or not.

In one embodiment, the device further includes a data processor configured to receive signals from the at least one optical detector.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 schematically illustrates features of the detection system according to the invention.

FIG. 2a illustrates exemplary embodiments of the sample holder according to the invention.

FIG. 2b illustrates an enlarged view of the electrodes in FIG. 2a.

FIG. 3 illustrates another embodiment of the sample holder of the invention.

FIG. 4 illustrates one embodiment of the optical detection system according to the invention.

FIG. 5 is a diagram with optical readout from three optical power detectors in an experiment using sterile urine specimen according to the invention.

FIG. 6 is a microscopic view of sample E. coli in an experiment without the application of electricity to the sample.

FIG. 7 is a microscopic view of the same sample E. coli shown in FIG. 6 with electricity applied to the sample, according to the invention.

FIG. 8 is a diagram with optical readout from three optical power detectors in an experiment using sample E. coli according to the invention.

FIG. 9 is a microscopic view of sample cocci in streptococcal chain in an experiment according to the invention.

FIG. 10 a diagram with optical readout from one optical power detector in an experiment using sample cocci in streptococcal chain according to the invention.

### DETAILED DESCRIPTION OF THE INVENTION

The disclosure will focus on application of the invention in detection and analyses of live bacteria, but will have broad applications in the detection and characterization of any non-isometric and dielectric analyte, whether the analyte is a single particle separate from other entities or is an aggregate of particles.

Bacteria come in one of three shapes: coccus (spherical), bacillus (rod-shaped), and spiral. While a single coccus shaped bacterium is spherical, most cocci form irregularly shaped chains and clusters due to normal cellular division. Therefore, most live bacteria are “non-isometric,” i.e., at least one of the lengths in one dimension in a three-dimensional system is not the same as the other lengths along the other two dimensions. Other terms describing non-isometric objects include “irregularly shaped” and “asymmetric,” which may be used in the present disclosure interchangeably with “non-isometric.” When living bacteria are immersed in a fluid (such as urine), the cellular membranes of the bacteria keep their internal permittivity different from the surrounding fluid. Due to this difference in permittivity, electric dipoles can be induced within the bacteria by applying an alternating (or AC) electric field across the surrounding fluid. The electric dipoles within the bacteria are attracted and repelled by the alternating electric field causing the bacteria to align in a preferential direction that minimizes the forces acting upon them, i.e., along the electric field. Again, this alignment only occurs in living bacteria with functional cellular membranes. Dead bacteria do not have a permittivity difference from the surrounding fluid and are not subject to alignment. The frequency of the applied electric field can be varied to account for the variation in pH from specimen to specimen.

In addition to an applied electromagnetic field, other forms of polarizing energy that would align the particles or substantially change their orientations include ultrasound, intense polarized laser light, and other options known to one skilled in the art.

The state of aligned particles can be distinguished from the state of randomly orientated particles by various techniques such as optical techniques. For example, optical scattering is one of many methods used to measure properties of small particles. A high intensity light source or a monochromatic, coherent, laser beam can be directed onto the particles, and one or more light detectors can be set up to measure the power of scattered light. Typically, smaller particles scatter light across a wider range of angles. Also, higher particle concentration scatters more light than lower particle concentration. By measuring the scattered power at different angles, different polarizations, and different light spectrum or color, it is possible to determine the size distribution and concentration of the particles being tested. In some embodiments, a high intensity unpolarized source, for example one or more LEDs, in conjunction with a polarizer can be used as a light source.

The present invention improves on the traditional optical scattering technique by also measuring the amount of alignment present in the sample. This additional signal allows the system to further distinguish between live and dead bacteria and to discriminate against crystals and amorphous particles of similar size sometimes present in a sample, e.g., the urine. Alignment in a test specimen can be detected and measured against a reference pattern previously generated from samples with confirmed particles. Alternatively, alignment can be detected and measured when light scattering pattern changes significantly when the polarizing energy is applied.

For example, non-isometric particles such as the bacteria Escherichia coli (also referred to as E. coli) are about 0.5 μm wide and about 1-2 μm long. Scattering from its narrower 0.5 μm width dimension is spread out across a broader range of angles than the scattering from the 1-2 μm length dimension. In a randomly orientated sample the observed scattering appears uniform. This is expected because scattering from each particle occurs at a random orientation, and the scattering sums such that the energy distribution as a function of the different transverse angles appears uniform. In an aligned sample, scattered intensity will show a distinctive pattern which can be measured to determine the amount of alignment, and therefore, the presence and the quantity of live bacteria in the sample.

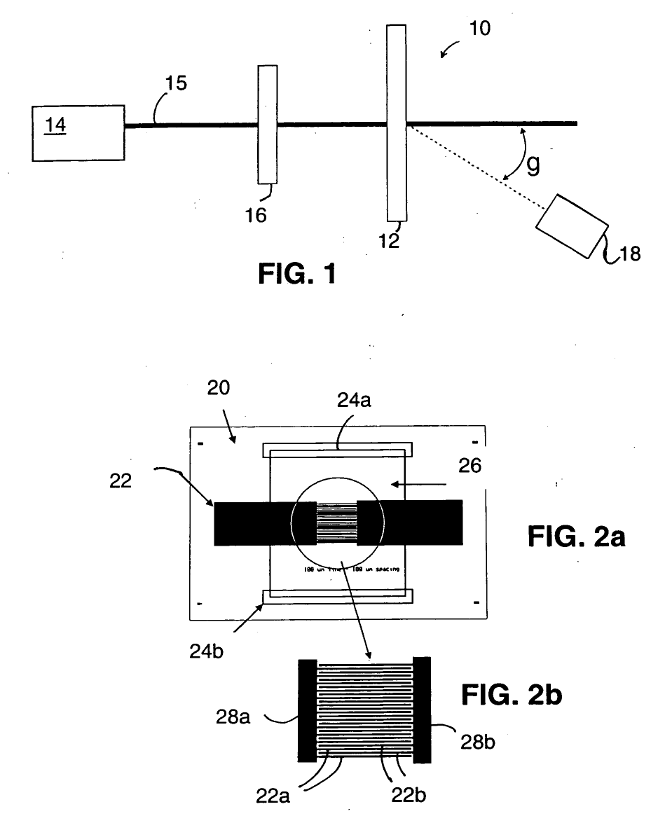

Referring to FIG. 1, a basic setup for the present system is now described. In one embodiment, a device 10 is provided for rapid detection of one or more dielectric, non-isometric analytes in a solution. The device includes a sample holder 12 where a volume of the sample is loaded into a loading space. The schematic illustration in FIG. 1 has the holder in a vertical orientation, but other orientations can be equally applicable. To one side of the holder 12 is an optical source 14 directed at the loading space of the holder 12. In one embodiment, the optical source 14 generates an expanded and collimated HeNe laser 15 that operates at 633 nm. The laser 15 passes through a ½-wave waveplate 16 for polarization control before it illuminates the sample holder 12. In one embodiment, the incident light beam reaches the loading space in a substantially perpendicular fashion, and a significant portion of the light will exit the holder 12. Some of the exiting light is refracted or reflected, and can be captured by one or more optical detectors 18. In one embodiment, the optical power detector 18 is placed at an angle g with respect to the incident beam 15 on the other side of the holder 12 from the optical source 14 as the holder 12 is substantially transparent. In other embodiments, the optical detector 18 is placed elsewhere, for instance, on the same side of the holder 12 with the optical source 14. In that case, a reflective backing can be added to the back of the holder 12 to increase the amount of light that is reflected off the loading space. This configuration may have a more compact footprint for the system. With multiple optical detectors, multiple angles of exiting light, reflected or refracted, can be captured to generate a more complete light scattering pattern. A source of polarizing energy (not shown) is situated in proximity to the loading space of the sample holder 12. In one embodiment, electrodes are manufactured into the sample holder adjacent the loading space so that they would be in direct contact with loaded sample solutions.

Referring now to FIG. 2a, an embodiment of the sample holder 12 is shown to include a transparent microscope slide 20 equipped with electrodes 22. In one embodiment, the slide 20 is about 1 mm thick, and the electrodes 22 are patterned. The electrodes 22 shown are interdigitated electrodes, for example made from photolithographically patterned indium tin oxide (ITO). Two spacers 24a and 24b are placed at two sides of the slide 20. A thin microscope slide cover 26 is placed on top of the spacers 24a and 24b.

FIG. 2b provides an enlarged view of the electrodes 22. In this particular embodiment, the electrodes 22 are in the form of interdigitated arrays. Each finger of electrode 22a is 100 μm in width and spaced 100 μm from an electrode finger 22b of the opposite polarity. Each electrode finger 22a of one polarity is connected to one conductive strip 28a, and each electrode finger 22b of other polarity is connected to another conductive strip 28b. The two strips are in turn connected to an ac voltage source. The electrodes 22 can be fabricated on the glass slide using standard lithography techniques. The interdigitated arrays of the electrodes 22 provide the loading space for liquid samples. Fluid specimen suspected of certain particles (e.g., urine infected with bacteria) is injected between the microscope slide and the glass cover glass, and drawn into the rest of the loading space by capillary action. In an alternative embodiment, a second electrode can be patterned on the microscope cover glass to increase the sensitivity and lower the voltage requirement.

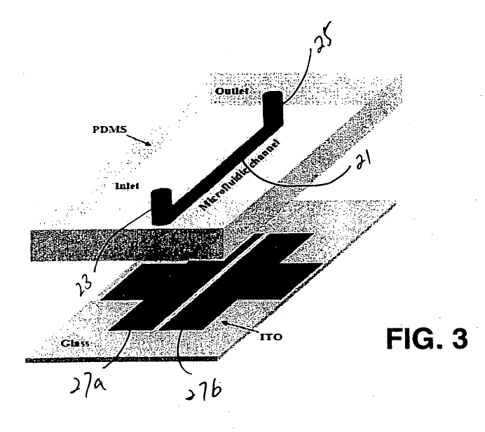

FIG. 3 illustrates yet another embodiment of the sample holder. Specifically, a microfluidic channel 21 with an inlet 23 and an outlet 25 coupled with a different electrode pattern is provided in the holder. The electrodes 27a and 27b, of opposite polarity, are aligned next to each other with a gap in between. The gap is designed to be slightly narrower than the microchannel 21 such that when the channel is superimposed on top of it, fluid in the channel 21 would contact both electrodes. In a preferred embodiment, the electrodes are made of indium tin oxide (ITO).

In a specific embodiment, the holder of FIG. 3 is manufactured as follows. The microfluidic channel 21 is fabricated using polydimethylsiloxane (PDMS). The fabrication uses the replica soft lithography technique. Once the partially cured PDMS is cut and peeled from a mold, the inlet and outlet ports are punched using a 23-gauge luer-stub adapter. The PDMS, as shown in FIG. 3, is attached to a 1 mm thick glass plate with the conductive electrode pattern, and left in the oven overnight at 80° C. to cure and bond to the substrate. The 200 μm wide channel holds approximately 50 nL of test specimen. The two ends of the electrodes (27a, 27b) are connected to a signal generator to provide a voltage of ±10 V at 10 MHz.

As will be shown in examples below, when the voltage is off, the live bacteria are randomly distributed and move around due to Brownian motion and self propulsion. When the voltage is applied, the live bacteria align with respect to the electric field.

In a preferred embodiment, the optical power detector is positioned in a plane perpendicular to the direction of the electric field in order to measure the scattering from one of the test analyte's smaller measurements, e.g., the narrower waist of a rod-shaped Lactobacillus acidophilus. Power measurements are taken before and after the ac voltage is applied. The difference and/or ratio of the measurements indicate the quantity of live bacteria present and aligned. The ac voltage can be cycled on and off (after a certain relaxation period for the bacteria to re-orient themselves through random motion) to take several measurements. Alternatively, the temporal scattering response is observed as the cells are aligning with the electric field. The ½-wave waveplate can also be rotated to introduce different polarizations to the sample holder. The system of the present invention is simple enough to be manufactured into a portable device that does not require any special reagent to operate.

The present invention has exhibited great advantages when applied to bacterial/pathogen detection, e.g., the detection of Escherichia coli and Lactobacillus acidophilus in urine. Societal costs of Urinary Tract Infection (UTI), one of the most common bacterial infections, are tremendous. According to one study, direct costs such as doctor visits, antimicrobial prescriptions, and hospitalization expenses, as well as the nonmedical costs associated with travel, sick days, and morbidity were estimated to be $659 million in 1995 for community-acquired UTI. Indirect costs of lost output were estimated to be $936 million, raising the figure to a total of $1.6 billion. The estimated annual cost of nosocomial UTI in 1995 is $424-$451 million.

Compared to traditional methods of bacterial detection, the present invention provides the following advantages:
(1) It does not require skilled technicians, bench top equipment, or even a microscope. The entire device can be packaged in a handheld form that is operated with a few buttons and has a low power requirement.
(2) For certain applications (such as urine analysis), a direct sample can be used without any sample preparation.
(3) Results can be obtained in seconds and at a point of care.
(4) The inexpensive sample holder is disposable, eliminating post-test clean up and potential carryover/contamination risks present in a reused sample holder, while allowing a high cycle rate.
(5) The system and method can discriminate between live and dead bacteria.
(6) Non-dielectric particles are unaffected by the electric field and therefore do not contribute to the target signal. The low-noise background is particularly useful in urine analysis where small stones and amorphous particles sometimes confuse traditional methods that count small particles.
(7) The method can detect the presence of a wide range of bacteria by targeting a common physical characteristic, thus avoiding the need for targeting multiple specific antigens, enzymes, or receptors to analyze the diversity of possible microbes.

In general, this invention can be applied to the detection and classification of any non-isometric dielectric particles immersed in a dielectric medium.

### EXAMPLE 1

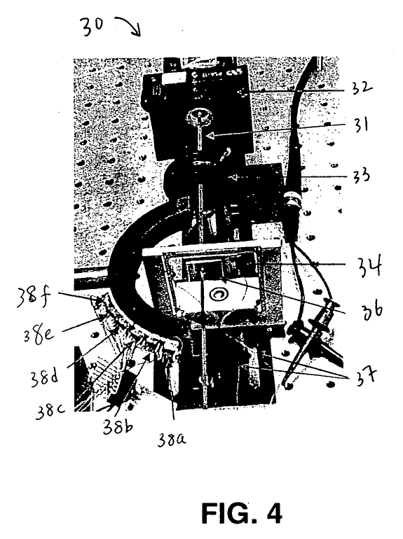

Referring to FIG. 4, an optoelectronic apparatus 30 built in accordance with the present invention is depicted. A 10 mW un-expanded HeNe laser beam 31 passed through a ½ waveplate 32 for polarization control, and through an iris 33 before illuminating the specimen holder 34. The specimen holder 34 comprised a 1 mm thick glass plate with a conductive electrode pattern and a thin cover glass 36 as depicted above in FIGS. 2 and 3. For the data disclosed below, the width of the electrodes and the spacing between the electrodes were both 100 μm. The active region between the glass plate and the cover glass held approximately 0.25 μL of test specimen, and the interaction volume with the 1.5 mm diameter laser beam was approximately 0.018 μL. The two ends of the electrodes were connected through wires 37 to a signal generator that was set to provide +10 Vp-p at 10 MHz when activated. An array of six photodiode optical power detectors 38a-38f were placed at different angles with respect to the laser beam, and used to measure the optical scattering. A computer controlled analog-to-digital converter recorded the outputs of the photodiodes as a function of time.

Sterile urine specimens were first used to test the apparatus 30 of the invention. A filtered and sterilized urine specimen containing 20% glycerol, pH 7, was loaded onto the specimen holder 34. To prepare this sample, clinical samples not individually identifiable were screened on the Chatsworth, Calif.-based IRIS International, Inc. iQ®200 Urinalysis System to select those specimens with a low particle count and pH 7. The selected samples were pooled. Both the selected and pooled samples were filtered (0.2 μm) to remove any remaining particles and retested for pH. The urine was stored at 4° C. and heated to 37° C. for 10 minutes before use to dissolve any possible new crystal formation.

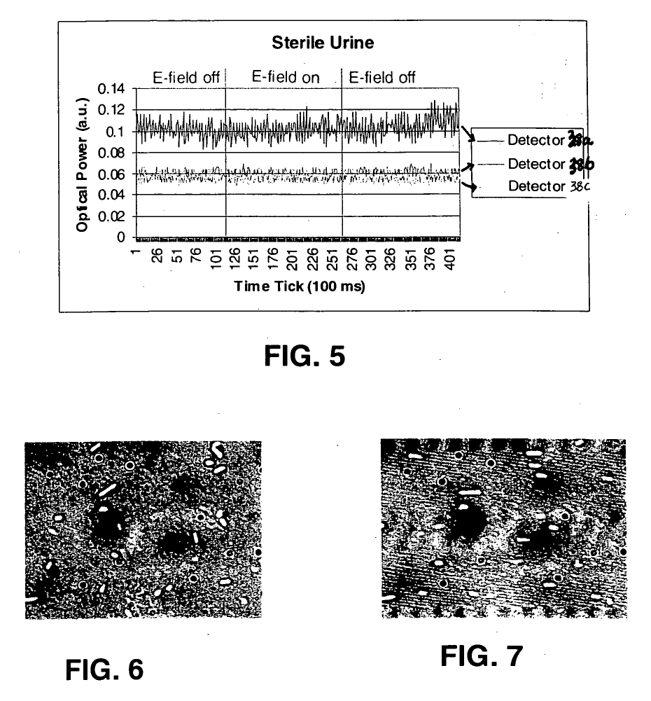

FIG. 5 shows the experimental data collected using the sterile urine specimen. After an initial settling period of approximately 12 seconds, the electrodes were activated for 15 seconds and then shut off. Optical power measurements were taken at 100 ms intervals prior to, during, and after the application of the electric field. Three readouts shown in FIG. 5 were, from top to bottom in the chart, generated by Detector 38a, 38b, and 38c (see FIG. 4), respectively. Detector 38a at the smallest angle with respect to the incident laser collected more light than the other detectors. Outputs from Detectors 38d through 38f were in the noise range of the detection system and therefore not shown (similar to Detectors 38b and 38c).

The flat output from Detector 38a indicates that the sterile urine's scattering did not increase appreciably when subject to an electric field. This was the expected result since the specimen did not contain any bacterium or particle that would be affected by the electric field.

In the next experiment, E. coli were grown to log phase, as monitored by Optical Density. Final concentration was determined by counting on a hemocytometer. The sample was stored at −20° C. in 20% glycerol at a concentration of 8.7×10⁸ CFU per milliliter. To enable visual observation of the effects of an applied electric field on E. coli, the specimen holder was loaded with the sample and removed from the optical setup and placed under a microscope. FIG. 6 shows the random orientation of E. coli as first introduced into the specimen holder and without application of electricity. FIG. 7 shows the alignment of the bacteria in the horizontal direction after the electrodes were activated. Both figures were captured at 500× magnification. Viscosity of the sample medium may be reduced in order to further reduce time needed for aligning the test analytes, especially for larger analytes. When the electric field was turned off, the orientation of the bacteria quickly redistributed randomly due to Brownian motion and self propulsion.

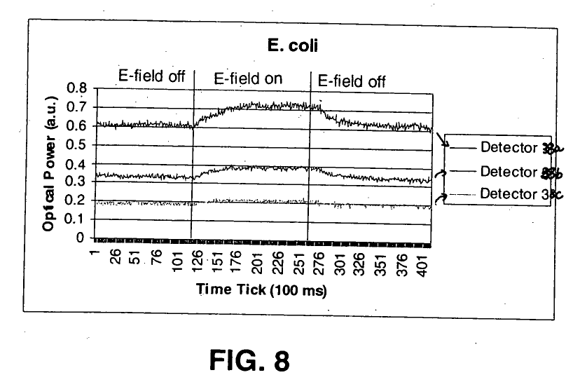

FIG. 8 shows the detector outputs from the optical setup with the same specimen observed in FIGS. 6 and 7. The baseline scattering was much higher than the filtered urine specimen provided in FIG. 5. For Detector 38a, for example, the baseline reading was 0.6 a.u. verses 0.1 a.u. This measurement could be used to determine the presence and concentration of particles in the specimen, e.g., after reference baseline readings of known concentrations have been established. After the electrodes were activated, a noticeable increase in scattering was recorded by each of Detectors 38a, 38b, and 38c, as expected from alignment of live E. coli under the influence of the electric field. The increase in scattering decayed back to baseline once the electric field was turned off. The rise/fall time and the magnitude of the increase in scattering from all the detectors could be used to determine the size and concentration of the bacteria in the specimen. At the stated concentration and interaction volume, approximately 16,000 E. coli bacteria were illuminated by the laser and contributed to the signal.

The same experiment was repeated with Lactobacillus acidophilus and a response similar to FIG. 8 was observed.

The above experiment was also repeated with dead E. coli (prepared by heating the same E. coli used above) and 5 samples of amorphous particles prepared as follows. Clinical specimens that were not individually identifiable were screened on the iQ®200 for samples with a high count for small particles (greater than 10,000 per microliter). The presence of amorphous particles was confirmed from images taken by the iQ®200. Three samples represented amorphous urates, and two samples represented amorphous phosphates. The resulting outputs from the same optical setup were similar to FIG. 5 where no discernable change in scattering was observed when the electrodes were activated. When viewed under the microscope, the dead E. coli with non-functional cellular membranes and the amorphous particles did not align with the applied electric field.

### EXAMPLE 2

The present invention's application in the diagnosis of infections other than UTI was also tested.

Streptococcal samples were obtained from a buccal swab plated on thioglycolate agar. Colonies were picked and grown overnight. Bacteria were identified by bright field microscopy and confirmed by fluorescence microscopy for adsorption of DNA intercalating dye Syto 24™. Cells were counted on a hemocytometer. Samples were stored at −20° C. in 20% glycerol at a concentration of 1.47×10⁸ CFU per milliliter.

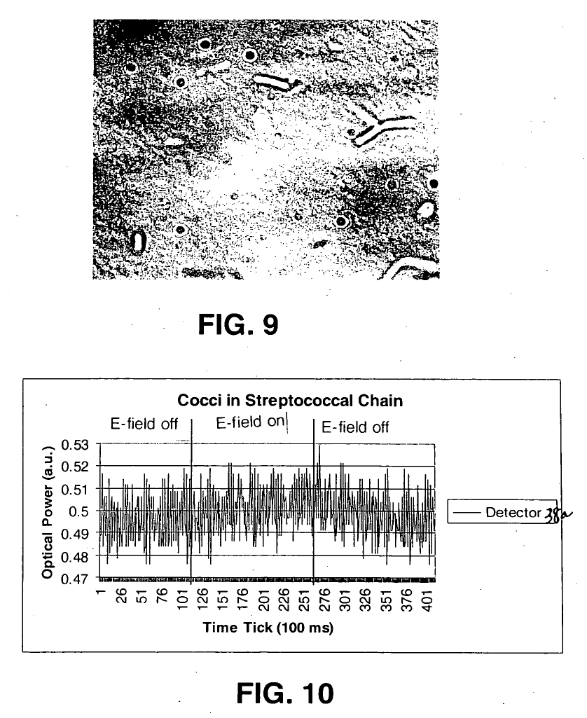

FIG. 9 shows, at 500× magnification, a specimen of cocci in streptococcal chain at a concentration of 1.47×10⁸ CFU per milliliter. As the picture shows, the bacteria clearly formed an elongated chain that is non-isometric. FIG. 10 shows output from the optical setup depicted above with reference to FIG. 4. The concentration of this specimen is approximately 60 times lower than the E. coli specimen tested in the Example 1. Approximately 260 bacteria were illuminated by the laser beam and the scattered light recorded by Detector 38a was weaker but still showed a noticeable increase when the electrodes were activated.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A device for detecting one or more dielectric and non-isometric analytes in a solution, the device comprising:
a holder defining a loading space for loading a volume of a solution;
a source of polarizing energy in proximity to the loading space of the holder;
an optical source configured to direct a light at the loading space; and
at least one optical detector configured to detect light scattered from the loading space.

2. The device of claim 1 wherein the polarizing energy comprises an electromagnetic field.

3. The device of claim 1 wherein the polarizing energy comprises ultrasound.

4. The device of claim 1 wherein the polarizing energy comprises laser light.

5. The device of claim 1 wherein the source of polarizing energy and the at least one optical detector are located on different sides of the holder.

6. The device of claim 4 wherein the at least one optical detector is located at an angle to the incoming light path from the optical source to the loading space.

7. The device of claim 1 wherein the holder comprises an electrode.

8. A method for detecting one or more dielectric and non-isometric analytes in a solution, the method comprising the steps of:
polarizing one or more dielectric and non-isometric analytes in a solution such that they are substantially aligned in the solution; and
detecting the alignment of the analytes as an indication of the existence of such analytes.

9. The method of claim 8 wherein the polarizing step comprises substantially aligning the analytes along an electromagnetic field.

10. The method of claim 8 wherein the polarizing step comprises using ultrasound or a laser light.

11. The method of claim 8 wherein the solution comprises a bodily fluid.

12. The method of claim 11 wherein the bodily fluid is urine.

13. The method of claim 8 wherein the analytes comprise a live bacterium.

14. The method of claim 8 wherein the analytes comprise an aggregate of substantially spherical particles.

15. The method of claim 8 wherein the analytes comprise individual particles separate from each other.

16. The method of claim 8 wherein analytes are substantially rod-shaped.

17. The method of claim 8 wherein the analytes are substantially spiral-shaped.

18. The method of claim 8 wherein the detecting step comprises using optical means to detect the alignment.

19. The method of claim 18 wherein the detecting step further comprises detecting a light scattering pattern from the solution.

20. The method of claim 19 wherein the detecting step further comprises detecting a change in the light scattering pattern based on whether the analytes are polarized or not.

21. A device for detecting live bacteria in a sample solution, the device comprising:
a sample holder defining a channel for holding the sample;
a pair of electrodes in proximity to the sample holder and configured to apply an electric field across the channel;
an optical source configured to direct a light at the channel; and
at least one optical detector configured to detect light scattered from the channel, and capable of detecting a change in the scatter light based on whether the electrodes are connected to a source of electric potential or not.

22. The device of claim 21, further comprising a data processor configured to receive signals from the at least one optical detector.
